(19) United States
(12) Patent Application Publication
(10) Pub. No.: US 2014/0083115 A1
(43) Pub. Date: Mar. 27, 2014

(54) ARTICLE WITH DIELECTRIC MIRROR COATING SYSTEM

(71) Applicant: Mark A. Von Nieda, S. Windsor, CT (US)

(72) Inventor: Mark A. Von Nieda, S. Windsor, CT (US)

(73) Assignee: UNITED TECHNOLOGIES CORPORATION, Hartford, CT (US)

(21) Appl. No.: 13/629,130

(22) Filed: Sep. 27, 2012

(51) Int. Cl. G02B 5/08; F02C 7/12

(52) U.S. Cl. 60/806; 359/883; 359/359; 60/772

(57) ABSTRACT

An article includes a substrate having a surface arranged to receive radiation. A thermal barrier coating system is disposed on the surface and includes a ceramic-based coating. A dielectric mirror coating system is disposed on the ceramic-based coating such that the ceramic-based coating is located between the dielectric mirror coating system and the substrate. The dielectric mirror coating system includes a plurality of higher refractive index layers interleaved in an alternating stacked arrangement with a plurality of lower refractive index layers. Each of the plurality of higher refractive index layers and the plurality of lower refractive index layers has a thickness that is about ¼ of a preselected wavelength of the radiation.

### BACKGROUND

This disclosure relates to the thermal protection of articles. Reflective coatings are known and used for the reduction of heat load on a particular component. As an example, the component may be made of a high temperature metallic alloy that is then coated with the reflective coating. In operation, the reflective coating reflects at least a portion of the heat radiation that the component is subjected to in order to maintain a component at a lower temperature.

### SUMMARY

An article according to an exemplary aspect of the present disclosure includes a substrate that has a surface that is arranged to receive radiation. A thermal barrier coating system is disposed on the surface and includes a ceramic-based coating. A dielectric mirror coating system is disposed on the ceramic-based coating such that the ceramic-based coating is located between the dielectric mirror coating system and the substrate. The dielectric mirror coating system includes a plurality of higher refractive index layers interleaved in an alternating stacked arrangement with a plurality of lower refractive index layers. Each of the plurality of higher refractive index layers and the plurality of lower refractive index layers has a thickness that is about ¼ of a preselected wavelength of the radiation.

In a further non-limiting embodiment, the plurality of higher refractive index layers are tantalum oxide and the plurality of lower refractive index layers are alumina.

In a further non-limiting embodiment of any of the foregoing examples, the plurality of higher refractive index layers and the plurality of lower refractive index layers are selected from the group consisting of metal oxides.

In a further non-limiting embodiment of any of the foregoing examples, a ratio of a total number N₁ of the plurality of higher refractive index layers to a total number N₂ of the plurality of lower refractive index layers is 1:1.

In a further non-limiting embodiment of any of the foregoing examples, the dielectric mirror coating system consists of thirty-two of the plurality of higher refractive index layers and the plurality of lower refractive index layers.

In a further non-limiting embodiment of any of the foregoing examples, the ceramic-based coating is yttria-stabilized zirconia.

In a further non-limiting embodiment of any of the foregoing examples, the ceramic-based coating has a columnar microstructure.

In a further non-limiting embodiment of any of the foregoing examples, the thermal barrier coating system includes a bond coat located between the ceramic-based coating and the substrate.

In a further non-limiting embodiment of any of the foregoing examples, the surface is arranged in a line-of-sight with a combustion source of a turbomachine for receiving radiation from the combustion source, and the radiation is infrared radiation.

In a further non-limiting embodiment of any of the foregoing examples, each of the plurality of higher refractive index layers and the plurality of lower refractive index layers have an individual thickness of 187.5 nanometers or greater.

In a further non-limiting embodiment of any of the foregoing examples, the radiation is infrared, and each of the plurality of higher refractive index layers and the plurality of lower refractive index layers have an individual thickness of 1.13 micrometers.

In a further non-limiting embodiment of any of the foregoing examples, the substrate includes surfaces that are not in the line-of-sight with the combustion source, and the surfaces that are not in the line-of-sight are free of the dielectric mirror coating system.

In a further non-limiting embodiment of any of the foregoing examples, the surfaces that are not in the line-of-sight and are free of the dielectric mirror coating system includes a suction side surface of an airfoil.

A turbomachine according to an exemplary aspect of the present disclosure includes a combustion source operable to emit radiation and a substrate that has a surface arranged in a line-of-sight with the combustion source to receive the radiation. The thermal barrier coating system is disposed on the surface.

In a further non-limiting embodiment of any of the foregoing examples, the plurality of higher refractive index layers are tantalum oxide and the plurality of lower refractive index layers are alumina.

In a further non-limiting embodiment of any of the foregoing examples, the plurality of higher refractive index layers and the plurality of lower refractive index layers are selected from the group consisting of metal oxides.

In a further non-limiting embodiment of any of the foregoing examples, a ratio of a total number N₁ of the plurality of higher refractive index layers to a total number N₂ of the plurality of lower refractive index layers is 1:1.

In a further non-limiting embodiment of any of the foregoing examples, the dielectric mirror coating system consists of thirty-two of the plurality of higher refractive index layers and the plurality of lower refractive index layers.

A method for reducing temperature of an article in a turbomachine from absorbed radiation according to an exemplary aspect of the present disclosure includes providing a substrate that has a surface arranged to receive the radiation. The substrate has the thermal barrier coating system disposed on the surface.

The method as recited in claim 19, wherein a ratio of a total number N₁ of the plurality of higher refractive index layers to a total number N₂ of the plurality of lower refractive index layers is 1:1.

The method as recited in claim 19, wherein the dielectric mirror coating system consists of thirty-two of the plurality of higher refractive index layers and the plurality of lower refractive index layers.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example turbomachine.

FIG. 2 illustrates an example combustion source and components that are in a line-of-sight with the combustion source.

FIG. 3A illustrates an example article having a dielectric mirror coating system.

FIG. 3B illustrates a cross-section of an airfoil having a dielectric mirror coating system on a leading end portion and suction side surface thereof.

FIG. 4 illustrates another example having a dielectric mirror coating system and a ceramic-based coating having a columnar microstructure.

FIGS. 5-9 show test results of a coated article versus uncoated article.

### DETAILED DESCRIPTION

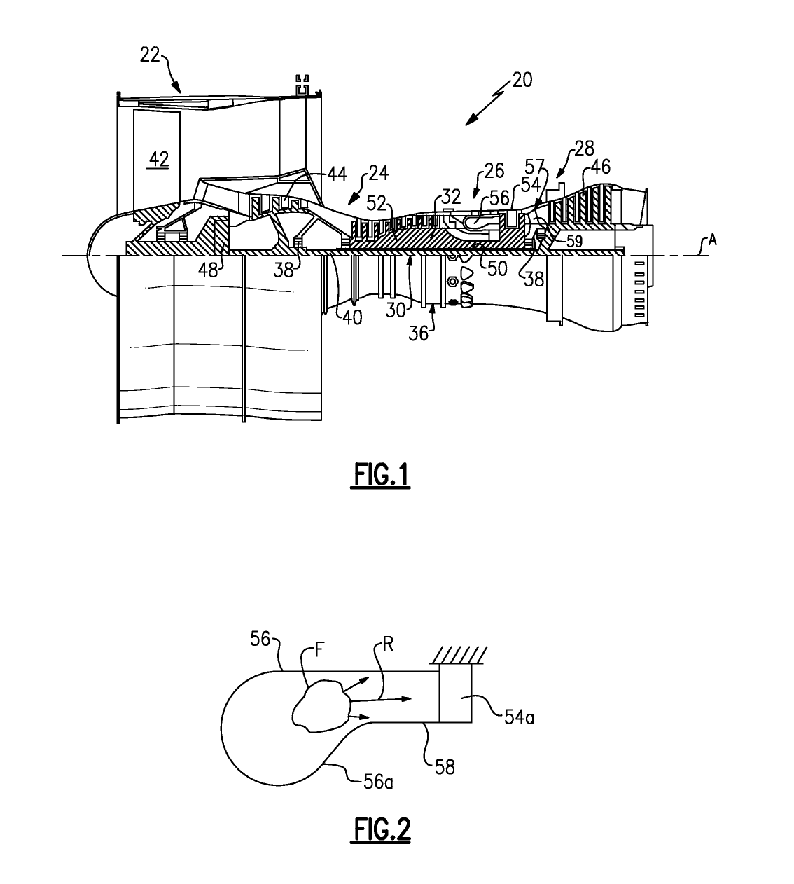

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section among other systems or features. The fan section 22 drives air along a bypass flowpath while the compressor section 24 drives air along a core flowpath for compression and communication into the combustor section 26 then expansion through the turbine section 28. Although depicted as a turbofan gas turbine engine in the disclosed non-limiting embodiment, it should be understood that the concepts described herein are not limited to use with turbofans as the teachings may be applied to other types of turbomachinery, including three-spool architectures and ground-based turbomachines.

The engine 20 generally includes a first spool 30 and a second spool 32 mounted for rotation about an engine central axis A relative to an engine static structure 36 via several bearing systems 38. It should be understood that various bearing systems 38 at various locations may alternatively or additionally be provided.

The first spool 30 generally includes a first shaft 40 that interconnects a fan 42, a first compressor 44 and a first turbine 46. The first shaft 40 is connected to the fan 42 through a gear assembly of a fan drive gear system 48 to drive the fan 42 at a lower speed than the first spool 30. The second spool 32 includes a second shaft 50 that interconnects a second compressor 52 and second turbine 54. The first spool 30 runs at a relatively lower pressure than the second spool 32. It is to be understood that “low pressure” and “high pressure” or variations thereof as used herein are relative terms indicating that the high pressure is greater than the low pressure. An annular combustor 56 is arranged between the second compressor 52 and the second turbine 54. The first shaft 40 and the second shaft 50 are concentric and rotate via bearing systems 38 about the engine central axis A which is collinear with their longitudinal axes.

The core airflow is compressed by the first compressor 44 then the second compressor 52, mixed and burned with fuel in the annular combustor 56, then expanded over the second turbine 54 and the first turbine 46. The first turbine 46 and the second turbine 54 rotationally drive, respectively, the first spool 30 and the second spool 32 in response to the expansion.

The engine 20 in the illustrated example is a high-bypass geared aircraft engine that has a bypass ratio that is greater than about six (6), with an example embodiment being greater than ten (10), the gear assembly of the fan drive gear system 48 is an epicyclic gear train, such as a planetary gear system or other gear system, with a gear reduction ratio of greater than about 2.3:1 and the first turbine 46 has a pressure ratio that is greater than about five (5). The first turbine 46 pressure ratio is pressure measured prior to inlet of first turbine 46 as related to the pressure at the outlet of the first turbine 46 prior to an exhaust nozzle. The first turbine 46 has a maximum rotor diameter and the fan 42 has a fan diameter such that a ratio of the maximum rotor diameter divided by the fan diameter is less than 0.6. It should be understood, however, that the above parameters are only exemplary.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 feet, with the engine at its best fuel consumption. To make an accurate comparison of fuel consumption between engines, fuel consumption is reduced to a common denominator, which is applicable to all types and sizes of turbojets and turbofans. The term is thrust specific fuel consumption, or TSFC. This is an engine's fuel consumption in pounds per hour divided by the net thrust. The result is the amount of fuel required to produce one pound of thrust. The TSFC unit is pounds per hour per pounds of thrust (lb/hr/lb Fn). When it is obvious that the reference is to a turbojet or turbofan engine, TSFC is often simply called specific fuel consumption, or SFC. “Low fan pressure ratio” is the pressure ratio across the fan blade alone, without a Fan Exit Guide Vane system. The low fan pressure ratio as disclosed herein according to one non-limiting embodiment is less than about 1.45. “Low corrected fan tip speed” is the actual fan tip speed in feet per second divided by an industry standard temperature correction of [(Tambient degree Rankine)/518.7]^{0.5}. The “Low corrected fan tip speed” as disclosed herein according to one non-limiting embodiment is less than about 1150 feet per second.

FIG. 2 schematically shows a cross-section of a portion of the annular combustor 56, which is operable as a combustion source to produce a flame, generally shown at F, to emit radiation R as fuel is burned. The radiation R may be primarily in the infrared range, which is generally has a wavelength of 750 nanometers to 1 millimeter. The wavelength may vary within the infrared range depending upon the design of the annular combustor 56 and type of fuel used, for example. The radiation R is emitted along a line-of-sight and can impinge upon walls 56a of the annular combustor 56, cases 58 and first stage vanes 54a of the second turbine 54. Thus, the articles or components, such as the walls 56a cases 58, first stage vanes 54a and any other components in the line-of-sight of the combustion source, are subject to increased temperatures from the absorption of the radiation R. It is to be further understood that although the annular combustor 56 is shown the in this example as the combustion source, the examples herein are not limited to the annular combustor 56. As another example, the combustion source can be any component that generates a flame that emits radiation R. In a further example, the combustion source may be an augmentor of an engine in a trailing end nozzle of an engine.

As will be described in more detail below, any of the components, or selected surfaces thereof, which are in the line-of-sight of the radiation R can be provided with a dielectric mirror coating system to facilitate thermal protection of the component from the radiation R.

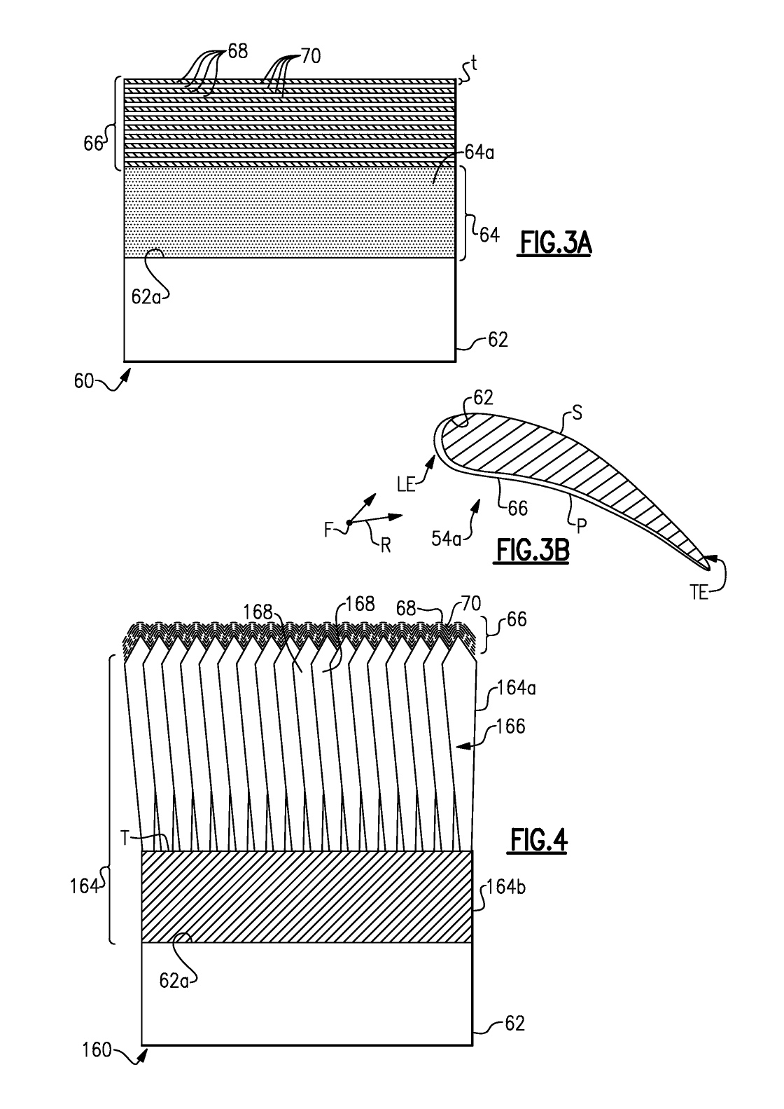

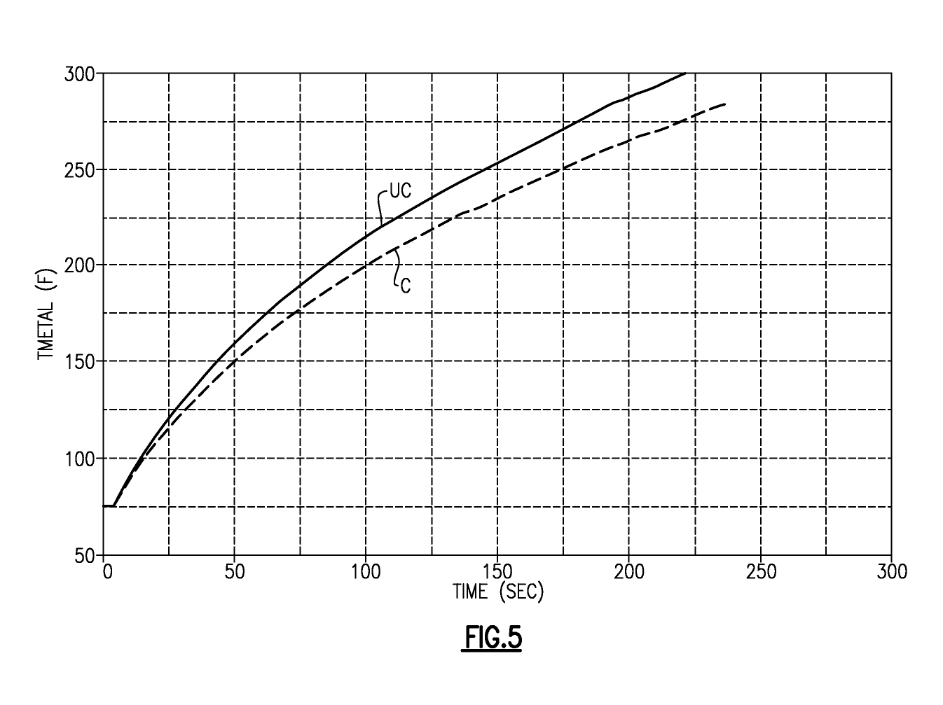

FIG. 3A illustrates a portion of an example article 60, which can be any of the components shown in FIG. 2, such as the combustor wall 56a, cases 58 or first stage vanes 54a. In this example, article 60 includes a substrate 62 having a surface 62a that is arranged in the line-of-sight of the combustion source to receive the radiation R. The substrate 62 can be a superalloy material, such as a nickel- or cobalt-based alloy.

The article 60 also includes a thermal barrier coating system 64 that is disposed on the surface 62a. The thermal barrier coating system 64 includes a ceramic-based coating 64a. As used in this disclosure, a “ceramic-based coating” is at least one coating layer having a composition that is primarily ceramic material. In one example, the ceramic-based coating 64a is or includes yttria-stabilized zirconia.

The article 60 further includes a dielectric mirror coating system 66 that is disposed on the ceramic-based coating 64a such that the ceramic-based coating 64a is located between the dielectric mirror coating system 66 and the substrate 62. In this example, the dielectric mirror coating system 66 is disposed directly on, and in contact with, the ceramic-based coating 64a.

As shown in the cross-sectional view of the first stage vane 54a in FIG. 3B, the surface 62 that has the dielectric mirror coating system 66 can be the leading edge and pressure side (P) surfaces that are in the line-of-sight. Optionally, the dielectric mirror coating system 66 can be excluded from other surfaces, such as the suction side (S), which are not in the line-of-sight of the radiation R. In the example shown, only the surfaces that are in the line-of-sight have the dielectric mirror coating system 66, and any surfaces such as the suction side surface that are not in the line-of-sight are free of the dielectric mirror coating system 66.

Referring again to FIG. 3A, the dielectric mirror coating system 66 includes a plurality of higher refractive index layers 68 that are interleaved in an alternating stacked arrangement with a plurality of lower refractive index layers 70 (“layers 68/70”). Each of the layers 68/70 has a thickness that is about ¼ of a preselected wavelength of the radiation R. The term “about” used in this disclosure with regard to the layer thicknesses indicates that the layer thickness may vary due to manufacturing tolerances, for example. Generally, the variation is not more than +/−10% of the target thickness, or more preferably is not more than +/−5% of the target thickness. Partial reflection of the incident radiation R occurs at each interface between the layers 68/70 to produce coherent, in-phase reflected radiation that results in a high-reflectivity that can approach 100%.

The composition of the materials selected for the layers 68/70, in combination with the individual thicknesses of the layers 68/70, can be selected to tailor the reflective performance of the dielectric mirror coating system 66 to a primary wavelength of the radiation R. For example, in gas turbine engines, such as the engine 20 shown in FIG. 1, the radiation R is primarily in the infrared wavelength range. In such an example, the individual thicknesses, t, of each of the layers 68/70 is selected to be about ¼ of a preselected wavelength of the radiation R. For radiation that is in the infrared wavelength range, the individual layer thickness t is 187.5 nanometers or greater. In a further example, the individual layer thicknesses t is also less than 250 micrometers. Selection of the alternating layer thicknesses is done by determining the primary emittance wavelength range within the infra-red spectrum of approximately 750 nanometers to 1.0 millimeter. This primary wavelength varies depending on the fuel used, the fuel-air ratio, as well as the pressures and temperatures of the combustion. With these parameters known, the primary emittance wavelength can be determined, and the desired ¼wavelength coating thickness tailored. As an example, a typical kerosene flame in a modern turbine engine combustor where the radiation is dominated by the combustion gas species has a peak emittance in the 4.5 micron wavelength range. In this case, the ideal coating layer thicknesses would be 1.13 microns. If the radiation is dominated by black body radiation from soot, the primary wavelength is ˜2 microns, so the ideal coating layer thickness would be 0.5 microns. Selecting the individual thickness to be about ¼ of the preselected wavelength of the radiation R facilitates enhancement of the reflectivity, also called the “stop band,” such that reflectivity can approach approximately 100% of the incident radiation R in the tailored radiation wavelength.

In combination with the above individual thicknesses, the composition of the materials selected for the layers 68/70 is selected from the group of metal oxides. In one example, the plurality of higher refractive index layers 68 are tantalum oxide (Ta₂O₅) and the plurality of lower refractive index layers are alumina (Al₂O₃). In other examples, the metal oxides of the layers 68/70 are independently selected from oxides of zirconium, hafnium, aluminum, calcium, silicon, titanium, rare earth metals, or combinations thereof. In further examples, the layers 68/70 are composed only of the selected metal oxides and any impurities.

Additionally, the effectiveness of the reflectivity of the dielectric mirror coating system 66 can depend upon the total number of layers 68/70 used. In one example, the dielectric mirror coating system 66 includes a total of thirty-two layers. In a further example, there are 16 layers each of the layers 68/70. Thus, there is a total number N₁ of the higher refractive index layers 68 and a total number N₂ of the plurality of lower refractive index layers 70 such that a ratio of N₁:N₂ is 1:1.

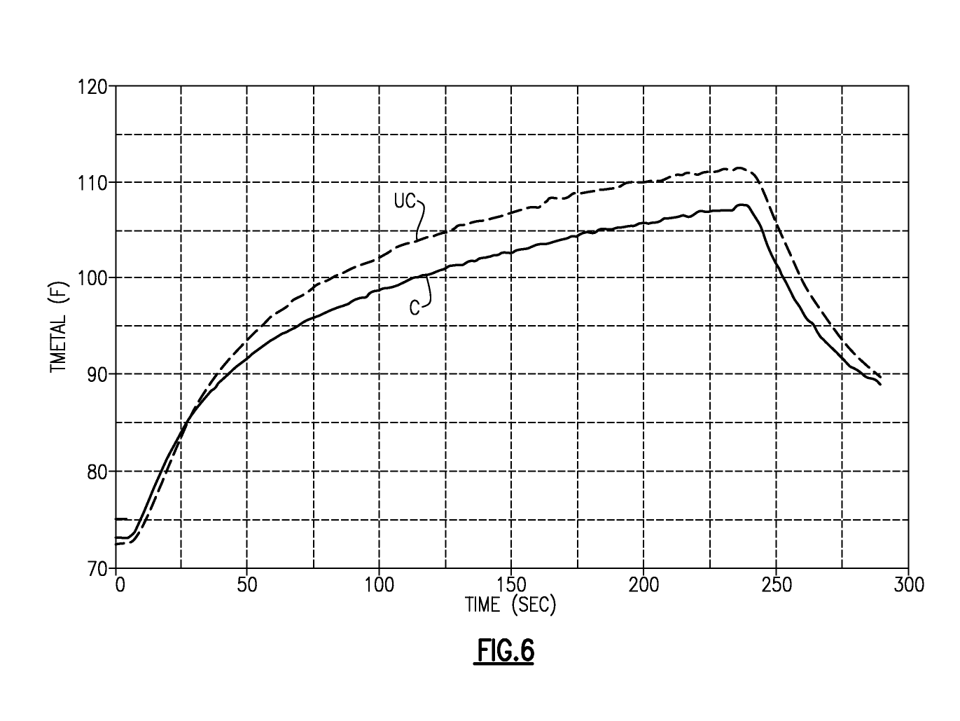

FIG. 4 illustrates a representative portion of another example article 160. In this disclosure, like reference numerals designate like elements where appropriate and reference numerals with the addition of one-hundred designate modified elements that are understood to incorporate the same features and benefits of the corresponding elements. In this example, the article 160 includes the substrate 62 and a thermal barrier coating system 164 disposed on the surface 62a of the substrate 62. Here, the thermal barrier coating system 164 includes a ceramic-based coating 164a and a bond coat 164b. The bond coat 164b is located between the ceramic-based coating 164a and the substrate 62. In one example, the bond coat 164b is an MCrAlY coating, where M includes at least one of nickel, cobalt and iron, Cr is chromium, Al is aluminum and Y is yttrium. Optionally, the bond coat 164b can also include an oxide scale, such as an alumina scale.

In this example, the ceramic-based coating 164a includes a microstructure 166 that has columns 168 that extend along a direction that is generally perpendicular to the plane of a top surface T of the bond coat 164b. This columnar microstructure provides strain tolerance for cyclic spallation durability due to thermal expansion/contraction of the ceramic-based coating 166 and the underlying bond coat 164b and substrate 62.

In this example, the dielectric mirror coating system 66 is disposed on the columnar microstructure of the ceramic-based coating 164a. Because the layers 68/70 of the dielectric mirror coating system 66 are oxide-based ceramic materials, the selected oxides of the dielectric mirror coating system 66 are chemically compatible with the ceramic-based coating 164 with regard to the respective coefficients of thermal expansion. Thus, the ceramic-based coating 164a facilitates strong bonding of the dielectric mirror coating system 66 on the article 160. Moreover, the strain-relief properties of the columnar microstructure of the ceramic-based coating 164 extend to the dielectric mirror coating system 66 and the dielectric mirror coating system 66 is thus also very durable.

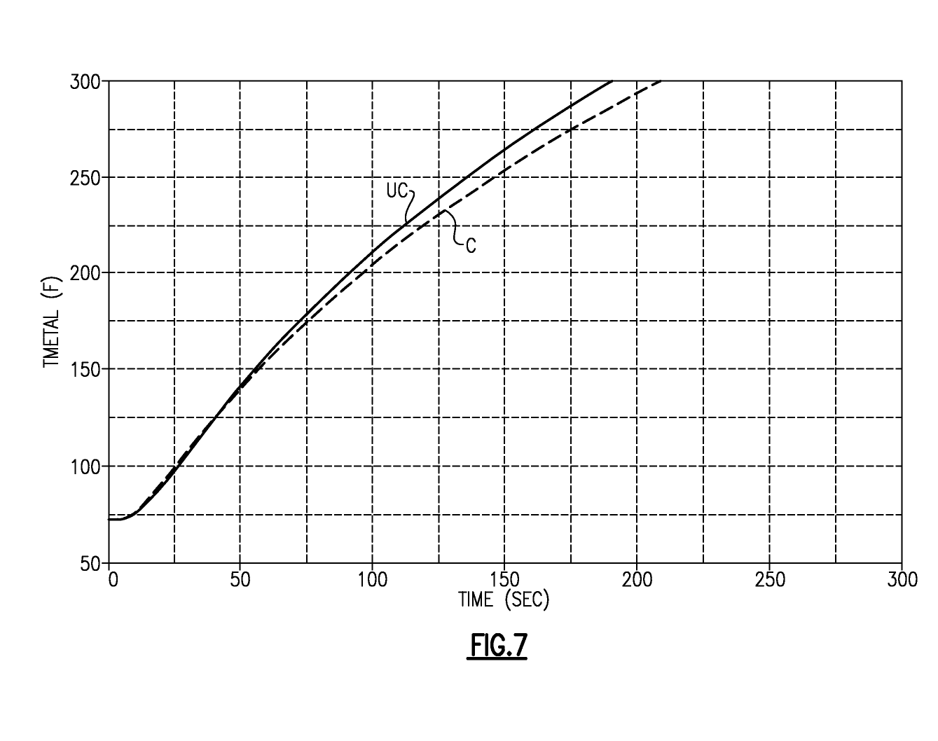

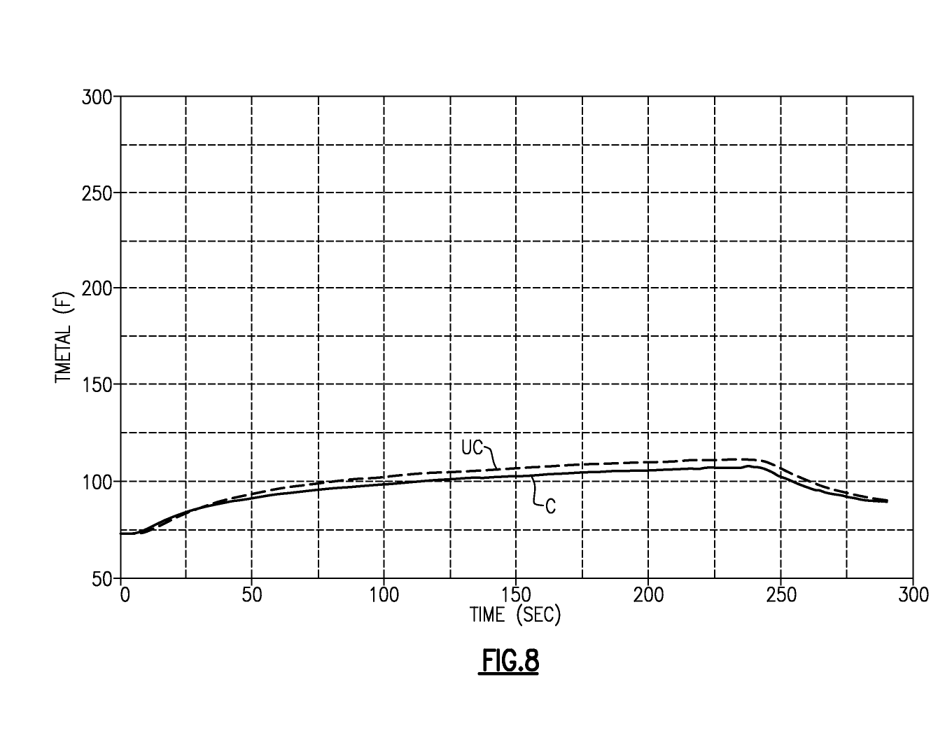

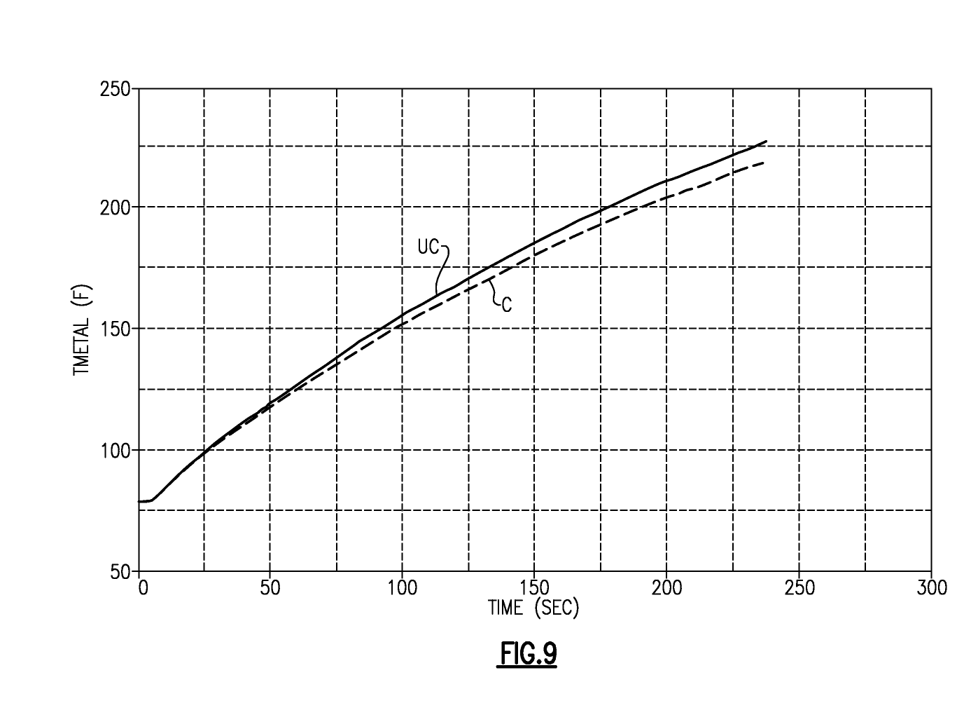

As indicated above, the dielectric mirror coating system 66 reflects radiation R and thus facilitates maintaining an article at a lower temperature. FIGS. 5 through 9 show the results of experiments that demonstrate the effectiveness of the dielectric mirror coating system 66. The experiments were conducted on turbine vane pairs with and without the dielectric mirror coating system 66. The dielectric coating system 66 included thirty-two alternating layers of tantalum oxide and alumina as the layers 68/70. In each experiment represented in FIGS. 5-9, a coated vane and an uncoated vane were exposed to a heat source arranged at a preselected distance from the test specimen. In FIG. 5, the preselected distance was 2 inches (50.8 mm); in FIG. 6 the distance was 5 inches (127 mm); in FIG. 7 the distance was 1 inch (25.4 mm); in FIG. 8 the distance was 0.5 inches (12.7 mm); and in FIG. 9 the distance was 2.4 inches (61 mm). The temperatures of the test specimens were measured versus time and are shown in each of the graphs in FIGS. 5-9. In each of the graphs, the lines designated UC represents the data of the uncoated vane and the line designated as C represents the coated vane. As shown in each of the graphs, there is a temperature differential between the uncoated vane and the coated vane, indicating that the dielectric mirror coating system 66 is effective to maintaining articles at lower temperatures. In actively cooled articles, the temperature differential would be expected to be even greater.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. An article comprising:
a substrate having a surface arranged to receive radiation;
a thermal barrier coating system disposed on the surface, the thermal barrier coating system including a ceramic-based coating; and
a dielectric mirror coating system disposed on the ceramic-based coating such that the ceramic-based coating is located between the dielectric mirror coating system and the substrate, the dielectric mirror coating system including a plurality of higher refractive index layers interleaved in an alternating stacked arrangement with a plurality of lower refractive index layers, each of the plurality of higher refractive index layers and the plurality of lower refractive index layers having a thickness that is about ¼ of a preselected wavelength of the radiation.

2. The article as recited in claim 1, wherein the plurality of higher refractive index layers are tantalum oxide and the plurality of lower refractive index layers are alumina.

3. The article as recited in claim 1, wherein the plurality of higher refractive index layers and the plurality of lower refractive index layers are selected from the group consisting of metal oxides.

4. The article as recited in claim 1, wherein a ratio of a total number N₁ of the plurality of higher refractive index layers to a total number N₂ of the plurality of lower refractive index layers is 1:1.

5. The article as recited in claim 1, wherein the dielectric mirror coating system consists of thirty-two of the plurality of higher refractive index layers and the plurality of lower refractive index layers.

6. The article as recited in claim 1, wherein the ceramic-based coating is yttria-stabilized zirconia.

7. The article as recited in claim 1, wherein the ceramic-based coating has a columnar microstructure.

8. The article as recited in claim 1, wherein the thermal barrier coating system includes a bond coat located between the ceramic-based coating and the substrate.

9. The article as recited in claim 1, wherein the surface is arranged in a line-of-sight with a combustion source of a turbomachine for receiving radiation from the combustion source, and the radiation is infrared radiation.

10. The article as recited in claim 1, wherein each of the plurality of higher refractive index layers and the plurality of lower refractive index layers have an individual thickness of 187.5 nanometers or greater.

11. The article as recited in claim 1, wherein the radiation is infrared, and each of the plurality of higher refractive index layers and the plurality of lower refractive index layers have an individual thickness of 1.13 micrometers.

12. The article as recited in claim 1, wherein the substrate includes surfaces that are not in the line-of-sight with the combustion source, and the surfaces that are not in the line-of-sight are free of the dielectric mirror coating system.

13. The article as recited in claim 12, wherein the surfaces that are not in the line-of-sight and are free of the dielectric mirror coating system includes a suction side surface of an airfoil.

14. A turbomachine comprising:
a combustion source operable to emit radiation;
a substrate having a surface arranged in a line-of-sight with the combustion source to receive the radiation;
a thermal barrier coating system disposed on the surface, the thermal barrier coating system including a ceramic-based coating; and
a dielectric mirror coating system disposed on the ceramic-based coating such that the ceramic-based coating is located between the dielectric mirror coating system and the substrate, the dielectric mirror coating system including a plurality of higher refractive index layers interleaved in an alternating stacked arrangement with a plurality of lower refractive index layers, each of the plurality of higher refractive index layers and the plurality of lower refractive index layers having a thickness that is about ¼ of a preselected wavelength of the radiation.

15. The turbomachine as recited in claim 14, wherein the plurality of higher refractive index layers are tantalum oxide and the plurality of lower refractive index layers are alumina.

16. The turbomachine as recited in claim 14, wherein the plurality of higher refractive index layers and the plurality of lower refractive index layers are selected from the group consisting of metal oxides.

17. The turbomachine as recited in claim 14, wherein a ratio of a total number N₁ of the plurality of higher refractive index layers to a total number N₂ of the plurality of lower refractive index layers is 1:1.

18. The turbomachine as recited in claim 14, wherein the dielectric mirror coating system consists of thirty-two of the plurality of higher refractive index layers and the plurality of lower refractive index layers.

19. A method for reducing temperature of an article in a turbomachine from absorbed radiation, the method comprising:
providing a substrate having a surface arranged to receive the radiation, the substrate having a thermal barrier coating system disposed on the surface, the thermal barrier coating system including a ceramic-based coating; and
reflecting the radiation using a dielectric mirror coating system disposed on the ceramic-based coating such that the ceramic-based coating is located between the dielectric mirror coating system and the substrate, the dielectric mirror coating system including a plurality of higher refractive index layers interleaved in an alternating stacked arrangement with a plurality of lower refractive index layers, each of the plurality of higher refractive index layers and the plurality of lower refractive index layers having a thickness that is about ¼ of a preselected wavelength of the radiation.

20. The method as recited in claim 19, wherein a ratio of a total number N₁ of the plurality of higher refractive index layers to a total number N₂ of the plurality of lower refractive index layers is 1:1.

21. The method as recited in claim 19, wherein the dielectric mirror coating system consists of thirty-two of the plurality of higher refractive index layers and the plurality of lower refractive index layers.
